(19) United States
(12) Patent Application Publication
(10) Pub. No.: US 2020/0217685 A1
(43) Pub. Date: Jul. 9, 2020

(54) NAVIGATION SYSTEM WITH MANEUVER GUIDANCE MECHANISM AND METHOD OF OPERATION THEREOF

(71) Applicant: TeleNav, Inc., Santa Clara, CA (US)

(72) Inventor: Kok Wei Koh, Mountain View, CA (US)

(21) Appl. No.: 16/712,369

(22) Filed: Dec. 12, 2019

Related U.S. Application Data
(60) Provisional application No. 62/788,623, filed on Jan. 4, 2019.

(51) Int. Cl. G01C 21/36; B60W 30/18; G08G 1/16; B60W 50/14; G06K 9/00

(52) U.S. Cl. CPC G01C 21/3658; B60W 30/18163; G08G 1/167; B60W 2050/143; G01C 21/3602; G06K 9/00798; B60W 50/14

(57) ABSTRACT

A navigation system includes: a first device configured to: monitor a lane position on a current road, receive a maneuver guidance based on the lane position, including an information phase, a preparation phase and an action phase prior to the first device making a driving maneuver, and detect a proximately located vehicle around the first device prior to announcing a navigation instruction including managing an announcement of the navigation instructions based on the lane position, the proximately located vehicle, and a distance to a navigation event on the current road.

### CROSS REFERENCE TO RELATED APPLICATION(S)

This application claims the benefit of U.S. Provisional Patent Application Ser. No. 62/788,623 filed Jan. 4, 2019, and the subject matter thereof is incorporated herein by reference thereto.

### TECHNICAL FIELD

An embodiment of the present invention relates generally to a navigation system, and more particularly to a system for vehicle lane-based guidance.

### BACKGROUND

Modern consumer and industrial electronics, especially devices such as graphical navigation systems, cellular phones, and vehicle integrated navigation and computing systems, are providing increasing levels of functionality to support modern life, including navigation and route guidance services. Research and development in the existing technologies can take a myriad of different directions.

Navigation devices and vehicle navigation services can give basic route directions, but occasionally the operator of the vehicle finds that they are unable to comply with the route guidance because they are in the wrong lane. Often traffic conditions can block the desired path if the operator is not properly positioned to execute the approaching maneuver. This can result in lost time, additional gas usage, making U-turns, schedule delays, and longer driving time to the destination.

Thus, a need still remains for a navigation system with a maneuver guidance mechanism for operator awareness while using a navigation system. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides a navigation system, including: a first device configured to: monitor a lane position of the first device on a current road, receive a maneuver guidance based on the lane position, including an information phase, a preparation phase and an action phase prior to the first device making a driving maneuver, and detect a proximately located vehicle around the first device prior to announcing a navigation instruction including managing an announcement of the navigation instructions based on the lane position, the proximately located vehicle, and a distance to a navigation event on the current road.

An embodiment of the present invention provides a method of operation of a navigation system including: monitoring a lane position of a first device; receiving a maneuver guidance by the first device based on the lane position, including an information phase, a preparation phase and an action phase prior to the first device making a driving maneuver; and detecting a proximately located vehicle around the first device prior to announcing a navigation instruction including managing an announcement of the navigation instruction based on the lane position, the proximately located vehicle, and a distance to a navigation event.

An embodiment of the present invention provides a non-transitory computer readable medium including instructions for execution including: monitoring a lane position of a first device; receiving a maneuver guidance by the first device based on the lane position, including an information phase, a preparation phase and an action phase prior to the first device making a driving maneuver; and detecting a proximately located vehicle around the first device prior to announcing a navigation instruction including managing an announcement of the navigation instruction based on the lane position, the proximately located vehicles, and a distance to a navigation event.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a navigation system with maneuver guidance mechanism in an embodiment of the present invention.

FIG. 2 is an example of a representation of a road lane model of the navigation system.

FIG. 3 is an example implementation of a maneuver mechanism including maneuver guidance of the navigation system.

FIG. 4 is another example of an open navigation session of the navigation system.

FIG. 5 is a further example of an open navigation session for providing the maneuver guidance of the navigation system.

FIG. 6 is an exemplary block diagram of the navigation system.

FIG. 7 is a further exemplary block diagram of a lane management system.

FIG. 8 is a block diagram of a control flow of the navigation system in an embodiment of the present invention.

FIG. 9 is a flow chart of a method of operation of the navigation system in a further embodiment of the present invention.

### DETAILED DESCRIPTION

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation.

The term “module” referred to herein can include specialized hardware supported by software in an embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof. Further, if a module is written in the apparatus claims section below, the modules are deemed to include hardware circuitry for the purposes and the scope of apparatus claims.

The modules in the following description of the embodiments can be coupled to one other as described or as shown. The coupling can be direct or indirect without or with, respectively, intervening items between coupled items. The coupling can be physical contact or by communication between items.

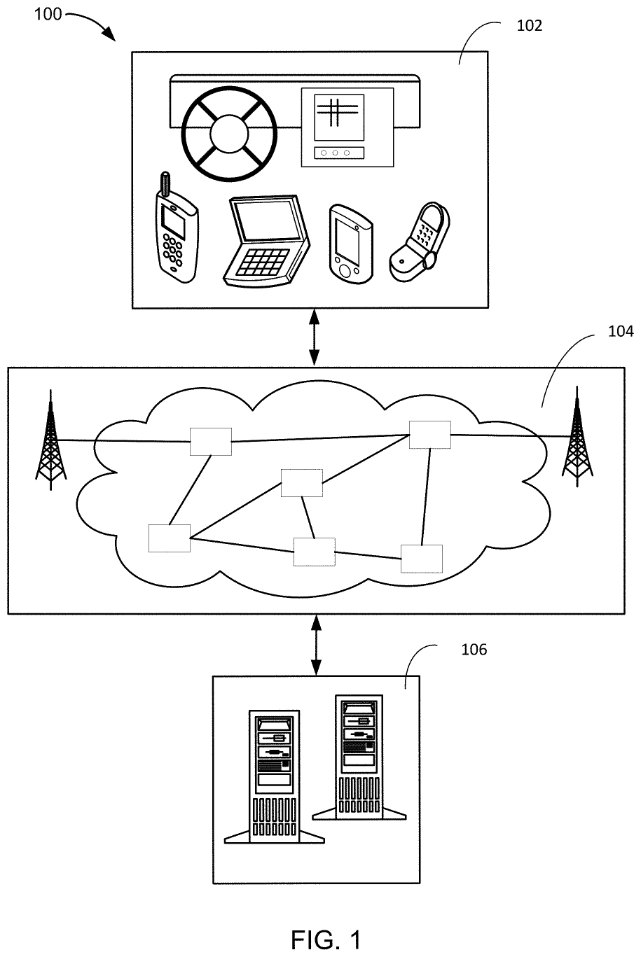

Referring now to FIG. 1, therein is shown a navigation system 100 with maneuver guidance mechanism in an embodiment of the present invention. The navigation system 100 includes a first device 102, such as a client or a server, connected to a second device 106, such as a client or server. The first device 102 can communicate with the second device 106 with a communication path 104, such as a wireless or wired network.

For example, the first device 102 can be of any of a variety of computing devices, such as a cellular phone, a tablet computer, a smart phone, a notebook computer, vehicle embedded navigation system, or computing device. The first device 102 can couple, either directly or indirectly, to the communication path 104 to communicate with the second device 106 or can be a stand-alone device.

The second device 106 can be any of a variety of centralized or decentralized computing devices, sensor devices to take measurements or record environmental information, such as sensor instruments, sensor equipment, or a sensor array. For example, the second device 106 can be a multimedia computer, a laptop computer, a desktop computer, grid-computing resources, a virtualized computer resource, cloud computing resource, routers, switches, peer-to-peer distributed computing devices, or a combination thereof.

The second device 106 can be mounted externally or internally to a vehicle, centralized in a single room or within a vehicle, distributed across different rooms, distributed across different geographical locations, or embedded within a telecommunications network. The second device 106 can couple with the communication path 104 to communicate with the first device 102.

For illustrative purposes, the navigation system 100 is described with the second device 106 as a computing device, although it is understood that the second device 106 can be different types of devices, such as a standalone sensor or measurement device. Also for illustrative purposes, the navigation system 100 is shown with the second device 106 and the first device 102 as end points of the communication path 104, although it is understood that the navigation system 100 can have a different partition between the first device 102, the second device 106, and the communication path 104. For example, the first device 102, the second device 106, or a combination thereof can also function as part of the communication path 104.

The communication path 104 can span and represent a variety of networks and network topologies. For example, the communication path 104 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104. Further, the communication path 104 can traverse a number of network topologies and distances. For example, the communication path 104 can include direct connection, personal area network (PAN), local area network (LAN), metropolitan area network (MAN), wide area network (WAN), a cellular telephone network, or a combination thereof.

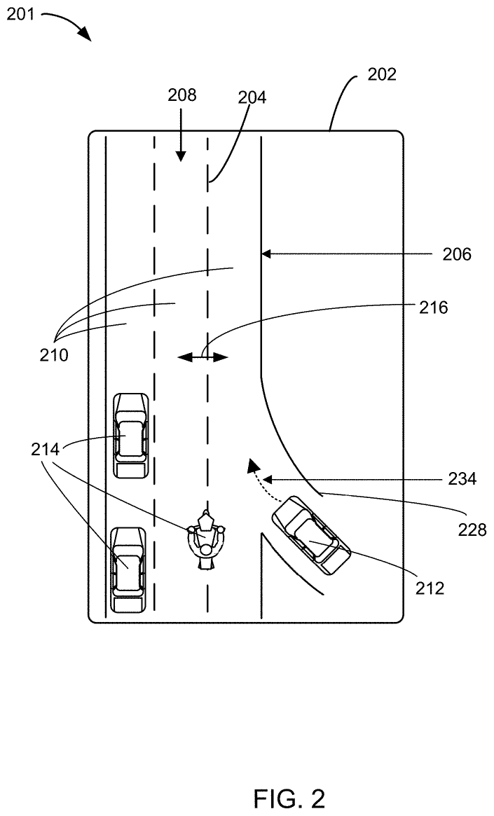

Referring now to FIG. 2, therein is shown a representation of a road lane model 201 of the navigation system 100. The road lane model 201 is an estimation of the lanes on a roadway. For example, the road lane model 201 can be localized to the geographic location around a user vehicle 212. The user vehicle 212 can be a vehicle occupied by the system user (not shown) of the first device 102, such as the occupant or operator of the user vehicle 212.

The road lane model 202 can include lane delineation estimations 204 for roadway lanes 210 on a roadway relative to the location of a user vehicle 212. The lane delineation estimations 204 are estimations or approximations of the roadway lanes 210 that divide vehicle traffic on the roadway. For example, the road lane model 202 can be localized to include the lane delineation estimations 204 for a current roadway 206, which is the roadway on which the user vehicle 212 is currently travelling. For example, the current roadway 206 can be a street, an alleyway, a highway, a freeway, a parkway, a toll road, or unpaved path.

In general, the lane delineation estimations 204 can correspond with the roadway lanes 210, which are the actual lane delineations on the roadway. As an example, reference objects in the environment around the user vehicle 212 can be used as a basis for alignment for the lane delineation estimations 204. The reference objects, for example, can include painted lane marking, raised pavement markers, reflective lane markers, traffic barriers, pylons, cones, flares, illuminators, other markings or features that indicate the existence of a traffic lane, or a combination thereof. As another example, the reference objects can include physical features of the roadway including gaps or edges between concrete or paved segments; metallic rails for trolleys or cable cars that embedded or integrated with the road way; changes in or transitions between the road surface such as from an asphalt, concrete, or paved surface to a gravel or unpaved surface which generally exist along the edge of a roadway; or a combination thereof.

The road lane model 202 can be used by the navigation system 100 to determine a lane position 208 of the user vehicle 212 on the current roadway 206. The lane position 208 identifies the roadway lanes 210 of the current roadway 206 in which the user vehicle 212 is located or entering.

In an implementation of the navigation system 100, the lane position 208 can be determined based on an initial point of entry of the user vehicle 212 onto the current roadway 206. For example, the lane position 208 can be based on a measurement of the number and direction of lateral shifts 216 in position along the current roadway 206 the user vehicle 212 has made since entry onto the current roadway 206.

For illustrative purposes, the initial point of entry is depicted as a lane merge section 228. The lane merge section 228 are sections of the current roadway 206 where two or more instances of the roadway lane 210 merge into a single instance of the roadway lane. As an example, the lane merge section 228 can include a highway on-ramp or off-ramp, an intersection with other roadways, instances or types of the current roadway 206, or an exit from a vehicle parking area.

In another implementation, the navigation system 100 can determine the lane position 208 of the user vehicle 212 based on information from a global navigation satellite system, global positioning system, cellular triangulation system, dead reckoning, or a combination thereof. Details for calculating the lane position 208 of the user vehicle 212 based on the road lane model 202 will be discussed below.

The navigation system 100 can include monitoring of proximately located vehicles 214. The proximately located vehicles 214 are vehicles within proximity to the user vehicle 212. For example, the proximately located vehicles 214 can be a vehicle that is within a specific range or distance of the user vehicle 212. An example of the specific range can be a predetermined value, such as within 100 or 1,000 feet, or a distance determined by the user or manufacture of the user vehicle 212. In another example, the specific range or distance can be based on limitations of sensors used to detect the proximately located vehicles 214. Details regarding these features will be discussed below.

It has been discovered that the navigation system 100 can monitor the proximately located vehicles 214 in order to provide warnings and a safe merging route 234. The navigation system 100 can help prevent accidents by maintaining awareness of the proximately located vehicles 214. The road lane model 201 can monitor the lateral shifts 216 of the user vehicle 212 in order to determine the lane position 208 of the user vehicle 212 on the current roadway 206. The counting of the lane change maneuvers can indicate which of the roadway lanes 210 in which the user vehicle 212 is operating. The lane position 208 can be based on a monitoring of the number and direction of lateral shifts 216 in position along the current roadway 206 the user vehicle 212 has made since entry onto the current roadway 206. By monitoring the proximately located vehicles 214 and the lane position 208 of the user vehicle 212, the navigation system 100 can provide safe navigation instructions. The navigation system 100 can improve traffic safety, reduce congestion, and assist in staying on a planned route by notifying the operator of the user vehicle 212 which lane position 208 they should be in to best prepare for the safe merging route 234.

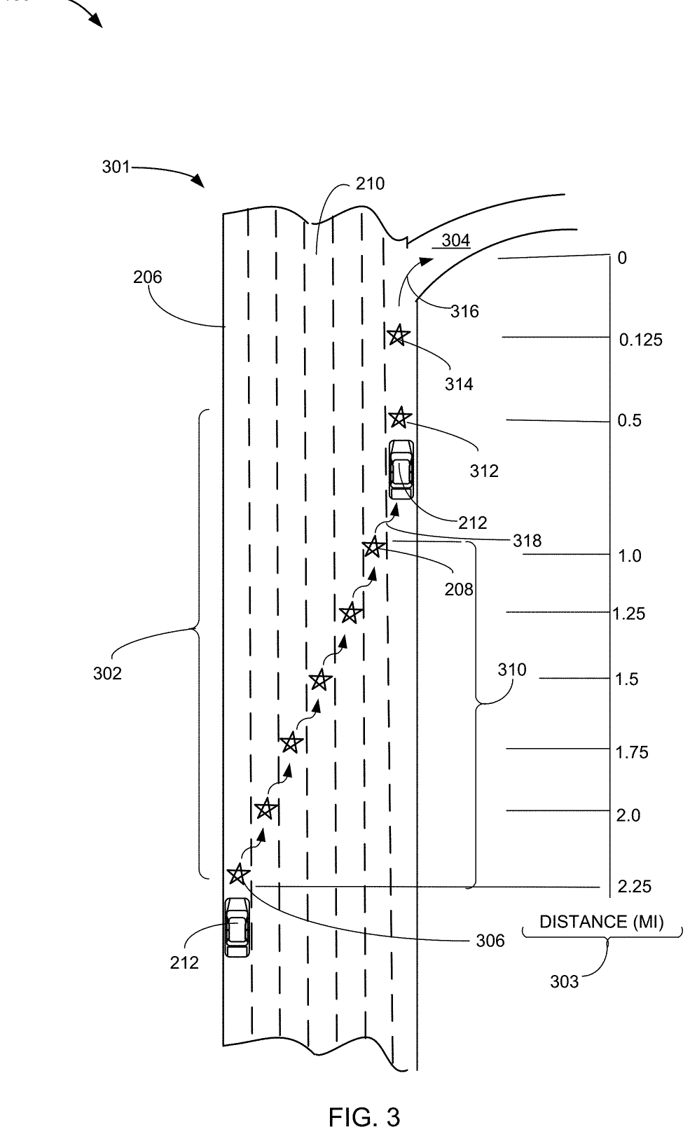

Referring now to FIG. 3, therein is shown an example implementation of a maneuver mechanism 301 including maneuver guidance 302 of the navigation system 100. The maneuver guidance 302 is guidance based on the lane position 208, a speed of the user vehicle 212 and a distance 303 to a navigation event 304. As a more specific example, the maneuver guidance 302 can be navigation-based guidance regarding the navigation event 304. The navigation event 304 is an event related to travel along the current roadway 206. An example of the navigation event 304 can be a change in the state of the roadway lane 210, such as exit or turn only lane, or merging with an adjacent instance of the roadway lane 210. An example of the maneuver guidance 302 can include a navigation instruction 306 for a driving maneuver to change the lane position 208 of the user vehicle 212 to exit the current roadway 206 based on the lane position 208.

In general, when a system user (not shown) is driving the user vehicle 212 with an active destination set in the navigation system 100 to provide navigation instructions 306 to the destination location, the navigation system 100 can provide turn-by-turn directions in the form of visual instructions, audio voice guidance, or a combination thereof. The notification timing for when the navigation instructions 306 are provided to perform a particular maneuver with the user vehicle 212 are usually based on an event distance 303, of the user vehicle 212 to the driving maneuver of the navigation event 304, and the vehicle speed that the user vehicle 212 is traveling, the current average vehicle speed on that section or portion of the current roadway 206, or the speed limit of that current roadway 206. The event distance 303 is the mileage between the user vehicle 212 and the navigation event 304.

As an example of the navigation event 304 of exiting the current roadway 206, in certain situations, the current roadway 206 the user vehicle 212 is currently traveling on can include multiple instances of the roadway lanes 210, such as a multi-lane road or highway, and it may be necessary for the user vehicle 212 to make a series of lane change maneuvers 318 prior to the navigation event 304. In this situation, the system user may require more time to perform the lane change maneuvers 318 compared to a vehicle that is already in the correct lane for the navigation event 304 of exiting the current roadway 206.

To continue the example, if not enough time is given to present the navigation instruction 306 for the navigation event 304, it is possible that the system user may miss the navigation event 304 of exiting the current roadway 206 or have to perform the lane change maneuver 318 in dangerous circumstances, such as making multiple lane changes in congested traffic. This situation can be compounded since a slower progress of the user vehicle 212 can delay the presentation of the navigation instructions 306. However, if the navigation instruction 306 is given with too much time prior to the navigation event 304, then there is a risk that the system user may take the wrong exit from the current roadway 206, or ignore the navigation instruction 306.

The navigation system 100 can use the current lane position 208 of the user vehicle 212 to dynamically adjust the notification timing and the notification frequency of the navigation notification for the maneuver guidance, the navigation event 304, or a combination thereof. In the example of the navigation event 304 of exiting the current roadway 206, the navigation system 100 can generate the navigation instruction 306 that is optimized to allow the vehicle driver (not shown) of the user vehicle 212 sufficient time to perform the lane change maneuvers 318 in order to reach the correct instance of the roadway lane 210 for the navigation event 304. For example, the more lane change maneuvers 318 that are required to reach the correct instance of the roadway lane 210, the earlier the navigation system 100 can provide the navigation guidance, which allows more time for the vehicle driver to react and get to the correct instance of the roadway lane 210 for the navigation event 304 of exiting the current roadway 206. Conversely, for example, the fewer of the lane change maneuvers 318 that are required to reach the correct instance of the roadway lane 210, the later the guidance is given (if at all), as less time is required to perform the lane change maneuvers 318 to reach the correct instance of the roadway lane 210 for the navigation event 304 of exiting the current roadway 206.

In general, the maneuver guidance 302 can include an information phase 310, a preparation phase 312, an action phase 314, or a combination thereof. The information phase 310 is the time frame at which the navigation instructions 306 are provided in preparation for performing the driving maneuver 316 for the navigation event 304 based on the lane position 208 of the user vehicle 212. As an example, for the navigation event 304 of exiting the current roadway 206, the information phase 310 can include the navigation instructions 306 to perform the lane change maneuvers 318 in preparation for the navigation event 304.

The preparation phase 312 is the time frame at which a notification is provided regarding the execution of the navigation event 304. For example, the preparation phase 312 can include the details regarding what should happen at the navigation event 304, such as the distance 303 to the navigation event 304 and what will occur at the navigation event 304, such as exit, merge, turn, or stop. The action phase 314 is the time frame at which the instructions for executing the driving maneuver provided to negotiate the navigation event 304.

For illustrative purposes, FIG. 3 is shown with the current roadway 206 including seven of the roadway lanes 210. However, it is understood that the current roadway 206 can have a different number of the roadway lanes 210. In this example illustration, if the navigation system 100 determines the lane position 208 of the user vehicle 212 is the left most of the roadway lane 210, the navigation system 100 can generate the maneuver guidance 302 to include the information phase 310 that will alert the system user at an event distance 303 of 2.25 miles in advance of the navigation event 304 of exiting the current roadway. To continue the example, the lane position 208 can determine the event distance 303 at which the maneuver guidance 302 is generated or presented for the navigation event 304, which can be at 2 miles to perform 5 of the lane change maneuvers 318 and can continue at increments of 0.25 miles for the number of the lane change maneuvers 318 are necessary to reach the correct one of the roadway lanes 210 for the navigation event 304 of exiting the current roadway 206. To further the example, when the navigation system 100 determines that the user vehicle 212 is in the correct one of the lane position 208, then the navigation system 100 can forego the information phase 310 and generate the maneuver guidance 302 to include the preparation phase 312, the action phase 314, or a combination thereof at the event distance 303 of 0.5 miles and 0.125 miles, respectively, to remain in the current instance of the roadway lane 210 and exit right ahead. Details regarding generation of the maneuver guidance 302 will be discussed below.

It has been discovered that the navigation system 100 can issue the maneuver guidance 302 to the user vehicle 212 including the navigation instructions 306. The operator of the user vehicle 212 can perform the lane change maneuver 318 in order to move toward the appropriate lane for the next planned maneuver, such as the navigation event 304. In the current example, by issuing a series of the navigation instructions 306, the navigation system 100 can guide the user vehicle 212 to the correct one of the lane position 208 in order to execute the navigation event 304. It is understood that the user vehicle 212 could otherwise be too many of the roadway lanes 210 away from the navigation event 304 in order to safely complete the maneuver. By issuing the navigation instructions 306, the navigation system 100 can remind the operator of the user vehicle 212 to prepare for performing the driving maneuver 316 for the navigation event 304. It is understood that only the number of the navigation instructions 306 required to get the user vehicle 212 in position for the navigation event 304.

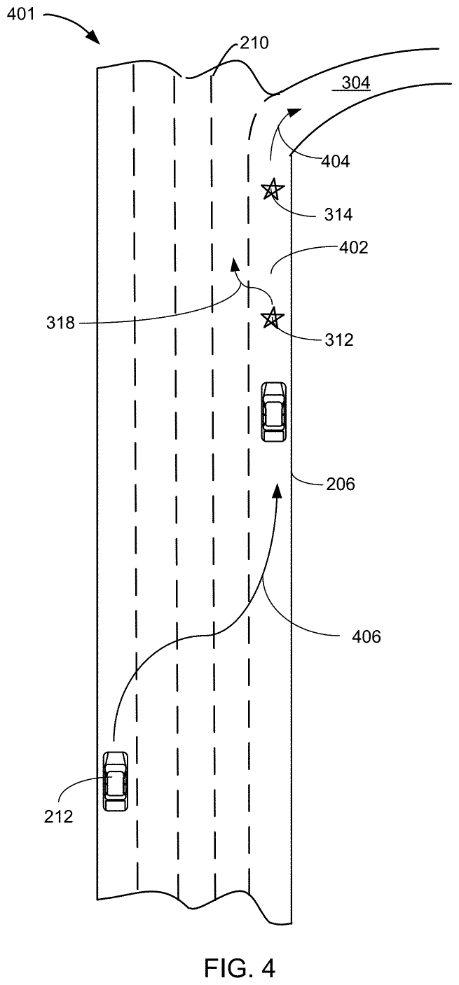

Referring now to FIG. 4, therein is shown another example of an open navigation session 401 of the navigation system 100. In this example of an open navigation session 401, the navigation system 100 can provide the navigation instruction 306 during the open navigation session 401. The open navigation session 401 can occur when the system user is using the navigation system 100 without an active navigation session. For example, the open navigation session 401 can be when the system user is driving the user vehicle 212 with the map interface currently displaying on a display interface of the first device 102 and the navigation system 100 is not engaged for providing navigation instructions 306 to a particular destination.

During the open navigation session 401, the navigation system 100 can generate the maneuver guidance 302 to provide the system user with information about the navigation event 304 that is specific to the particular instance of the roadway lane 210 that the user vehicle 212 is currently traveling in. For example, when the user vehicle 212 is traveling in the roadway lane 210 that is an exit-only lane 402, the navigation system 100 can generate the maneuver guidance 302 to inform the system user that the current roadway is the exit-only lane 402. More specifically, the navigation system 100 can provide the maneuver guidance 302 to include the action phase 314, the preparation phase 312, information phase 310, or a combination thereof.

In the situation illustrated in FIG. 4, the navigation system 100 operating in the open navigation session 401 depicts travel in the exit-only lane. In one implementation of the open navigation session, the navigation system 100 can generate the maneuver guidance 302 to include the preparation phase 312 to notify the system user that the user vehicle 212 is currently traveling in the exit-only lane 402 and can state “the lane exits right in 0.5 miles” when the user vehicle 212 is 0.5 miles away from the navigation event 304 of the roadway exit. As an example, in this implementation of the open navigation session, the navigation system 100 can forego the action phase 314, the information phase 310, or a combination thereof. More specifically, in the case that the system user intends to exit the current roadway 206 during the open navigation session, since the navigation system 100 does not have information regarding the intent or planned route of the system user, thus, the navigation system 100 can forgo generating the maneuver guidance 302 that includes the action phase 314 of instructions for the lane change maneuver 318. Similarly, the navigation system 100 can forgo generation of the maneuver guidance 302 with the information phase 310 since the user vehicle 212 is currently in the exit-only lane and the navigation system 100 does not have information regarding the intent or planned route of the system user.

It has been discovered that the navigation system 100 can operate in the open navigation session 401 to alert the operator of the user vehicle 212 that some maneuver will be required within a specific distance 303 of FIG. 3. By way of an example, the navigation system 100 when operating in the open navigation session 401, can alert the operator of an avoidable event 404. While the user vehicle 212 is travelling in the exit-only lane 402, the navigation system 100 can announce the preparation phase 312 by notifying the operator of the user vehicle 212 that “the lane exits right in 0.5 miles”. This announcement will allow the operator of the user vehicle 212 time to make the lane change maneuver 318 or continue to exit the roadway 206 by the navigation event 304. Since the navigation system 100 is unaware of the destination, once the announcement for the preparation phase 312 has been made, no announcement will be made at the action phase 314. The announcement at the preparation phase 312 can prevent the operator of the user vehicle 212 from getting into a dangerous last-minute execution of a multiple lane change maneuver 406 in order to enter or exit the exit-only lane 402.

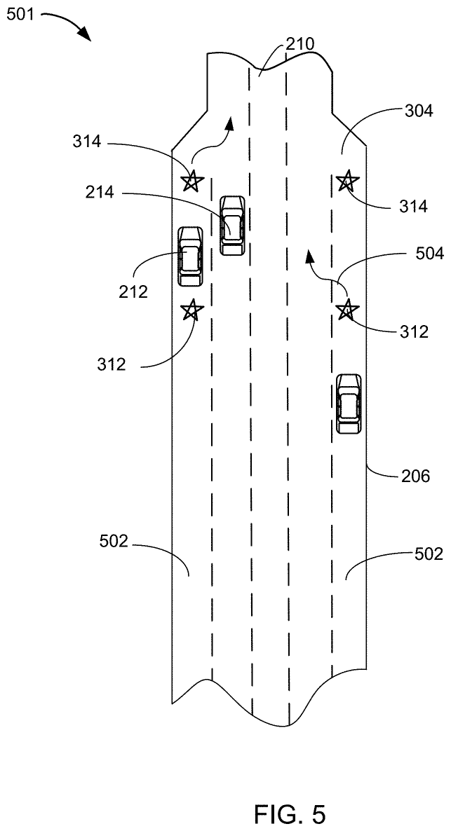

Referring now to FIG. 5, therein is shown a further example of an open navigation session 501 for providing the maneuver guidance 302 of the navigation system 100. In this implementation, the navigation system 100 can provide the maneuver guidance 302 that can generate the navigation instructions 306 in a further example of the open navigation session. FIG. 5 illustrates a scenario where particular instances of the roadway lanes 210 are terminated lanes 502 that will end with a lane merge into an adjacent instance of the roadway lanes 210. The terminated lanes 502 can be defined as portions of the roadway 206 that are not available to the user vehicle 212. The terminated lanes 502 can include road construction zones, traffic accident lane closures, the end of a previous one of the roadway lanes 210, such as a merging lane 502. In this scenario, if the lane position 208 of the user vehicle 212 is in the instance of the roadway lanes 210 that must merge, the navigation system 100 can identify the navigation event 304 as a lane change 504.

As an example, the navigation system 100 can generate the maneuver guidance 302 of FIG. 3 to include the action phase 314, the preparation phase 312, the information phase 310 of FIG. 3, or a combination thereof during the open navigation session with the navigation event 304 of the lane merger 504. As a specific example, the navigation system 100 can generate the maneuver guidance 302 to include the action phase 314 and the preparation phase 312, but forgo inclusion of the information phase 310. More specifically, when user vehicle 212 is traveling in the roadway lane 210 that includes the terminated lanes 502, the navigation system 100 can generate the maneuver guidance 302 with a notification that the roadway lane 210 will end with the lane merger 504 at a specific distance 303 of FIG. 3 or time. Further, navigation system 100 can generate the maneuver guidance 302 to include the action phase 314 with instructions to perform the lane change maneuvers 318 at a specific distance 303 or time before reaching the navigation event 304 of the lane merge. Yet further, since the user vehicle 212 is currently in the roadway lane 210 that includes the terminated lanes 502, it would not be necessary for the maneuver guidance 302 to include the information phase, since no additional maneuvers are necessary in preparation to respond to the navigation event 304.

For illustrative purposes, action phase 314 is shown with the guidance of “lane ends, merge right” or “lane ends, merge left” at a distance 303 of 0.125 miles, however it is understood that the action phase 314 can be generated with different guidance. For example, managing an announcement and the content of the navigation instructions 306 at the action phase 314 can be generated at different distances 303 from the navigation event 304 or based on the speed of the user vehicle 212. The content of the navigation instructions 306 can be modified, delayed, or issued sooner than scheduled based on the identification of the proximately located vehicles 214. In the event of a traffic accident causing the terminated lanes 502, the navigation system 100 can generate the maneuver guidance 302 to include the information phase 310 instructing the operator of the user vehicle 212 to merge into the lane position 208 that is not impacted by the traffic accident.

Also for illustrative purposes, the preparation phase 312 is shown with the guidance of “lane ends in 0.5 miles” although it is understood that the preparation phase 312 can be generated with different guidance. For example, the preparation phase 312 can be managed at different distances 303 from the navigation event 304 or based on the speed of the user vehicle 212. It is further understood that the navigation system 100 can present the maneuver guidance 302 that can alert the operator of the user vehicle 212 to merge to an adjacent one of the lane position 208 after the proximately located vehicles 214 has passed.

By way of an example the managing of the maneuver guidance 302 can include delaying the announcement of the maneuver command 306 until an adjacent one of the roadway lanes 210 is cleared by the proximately located vehicle 214 being allowed to pass. The navigation system 100 can issue the maneuver command 306 to include “allow proximately located vehicle to pass then change lanes to the left”. The managing of the maneuver guidance 302 can also include providing an early notification of the maneuver guidance 302 to alert the user vehicle 212 of traffic congestion ahead by announcing, “traffic congestion ahead, change lanes to the right when safe”. These notifications are managed by the navigation system 100 to allow the safe execution of the navigation instructions 306 of FIG. 3.

It has been discovered that the navigation system 100 can guide the user vehicle 212 into an adjacent one of the lane position 208 by delivering the appropriate set of the navigation instructions 306 to safely move out of the terminated lanes 502. If the user vehicle 212 performs the lane change 504 after the preparation phase 312, the action phase 314 can be omitted. In the case where the lane change 504 is blocked by the proximately located vehicles 214, the navigation system 100 can issue the navigation instructions 306 to include a warning of the added danger of the proximately located vehicles 214. In this case, both the preparation phase 312 and the action phase 314 can include a reminder of the proximately located vehicles 214 when making the lane change 504.

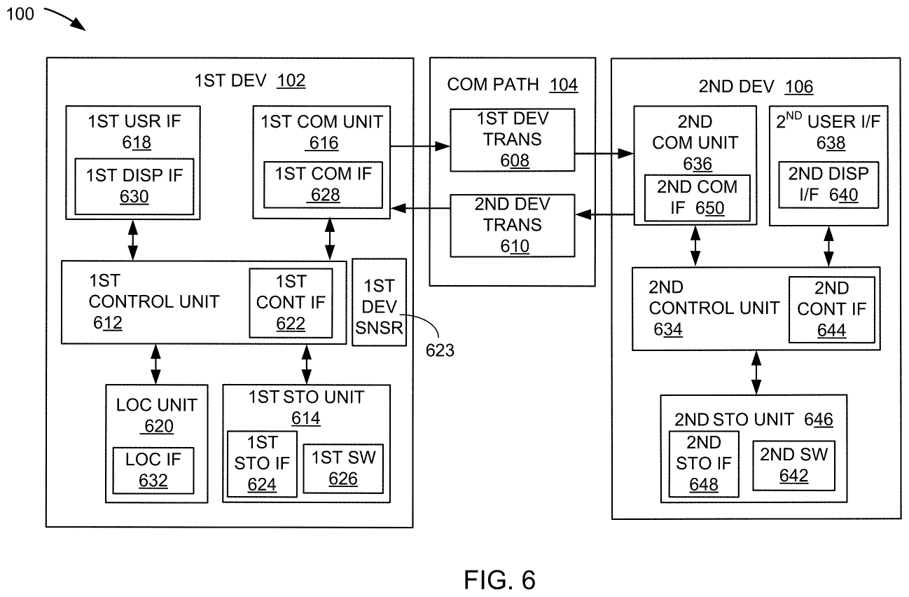

Referring now to FIG. 6, therein is shown an exemplary block diagram of the navigation system 100. The navigation system 100 can include the first device 102, the communication path 104, and the second device 106. The first device 102 can send information in a first device transmission 608 over the communication path 104 to the second device 106. The second device 106 can send information in a second device transmission 610 over the communication path 104 to the first device 102.

For illustrative purposes, the navigation system 100 is shown with the first device 102 as a client device, although it is understood that the navigation system 100 can have the first device 102 as a different type of device. For example, the first device 102 can be a server having a display interface. It is further understood that the first device 102 can be a vehicle telematics system including video and audio prompts for the operator (not shown).

Also, for illustrative purposes, the navigation system 100 is shown with the second device 106 as a server, although it is understood that the navigation system 100 can have the second device 106 as a different type of device. For example, the second device 106 can be a client device.

For brevity of description in this embodiment of the present invention, the first device 102 will be described as a client device and the second device 106 will be described as a server device. The embodiment of the present invention is not limited to this selection for the type of devices. The selection is an example of an embodiment of the present invention.

The first device 102 can include a first control unit 612, a first storage unit 614, a first communication unit 616, a first user interface 618, and location unit 620. The first control unit 612 can include a first control interface 622. The first control unit 612 can execute a first software 626 to provide the intelligence of the navigation system 100.

The first control unit 612 can be implemented in a number of different manners. For example, the first control unit 612 can be a processor, an application specific integrated circuit (ASIC) an embedded processor, a microprocessor, a hardware control logic, a hardware finite state machine (FSM), a digital signal processor (DSP), or a combination thereof. The first control interface 622 can be used for communication between the first control unit 612 and other functional units in the first device 102. By way of an example a first device sensor array 623 can be used to monitor conditions in and around the first device 102. The first device sensor array 623 can be number of hardware monitors coupled to the first control interface 622. The first control interface 622 can also be used for communication that is external to the first device 102.

The first control interface 622 can receive information from the other functional units or from external sources, or can transmit information to the other functional units or to external destinations. The external sources and the external destinations refer to sources and destinations external to the first device 102.

The first control interface 622 can be implemented in different ways and can include different implementations depending on which functional units or external units are being interfaced with the first control interface 622. For example, the first control interface 622 can be implemented with a pressure sensor, an inertial sensor, a microelectromechanical system (MEMS), optical circuitry, waveguides, wireless circuitry, wireline circuitry, or a combination thereof.

The location unit 620 can generate location information, current heading, and current speed of the first device 102, as examples. The location unit 620 can be implemented in many ways. For example, the location unit 620 can function as at least a part of a global positioning system (GPS) such as a GPS receiver, a global navigation satellite system (GNSS) receiver, an inertial navigation system, a cellular-tower location system, a pressure location system, or any combination thereof.

The location unit 620 can include a location interface 632. The location interface 632 can be used for communication between the location unit 620 and other functional units in the first device 102. The location interface 632 can also be used for communication that is external to the first device 102.

The location interface 632 can receive information from the other functional units or from external sources, or can transmit information to the other functional units or to external destinations. The external sources and the external destinations refer to sources and destinations physically separate from the first device 102.

The location interface 632 can include different implementations depending on which functional units or external units are being interfaced with the location unit 620. The location interface 632 can be implemented with technologies and techniques similar to the implementation of the first control interface 622.

The first storage unit 614 can store the first software 626. The first storage unit 614 can also store the relevant information. For example, first storage unit 614 can store information such as the map information.

The first storage unit 614 can be a volatile memory, a nonvolatile memory, an internal memory, an external memory, or a combination thereof. For example, the first storage unit 614 can be a nonvolatile storage such as non-volatile random access memory (NVRAM), Flash memory, disk storage, or a volatile storage such as static random access memory (SRAM).

The first storage unit 614 can include a first storage interface 624. The first storage interface 624 can be used for communication between and other functional units in the first device 102. The first storage interface 624 can also be used for communication that is external to the first device 102.

The first storage interface 624 can receive information from the other functional units or from external sources, or can transmit information to the other functional units or to external destinations. The external sources and the external destinations refer to sources and destinations external to the first device 102.

The first storage interface 624 can include different implementations depending on which functional units or external units are being interfaced with the first storage unit 614. The first storage interface 624 can be implemented with technologies and techniques similar to the implementation of the first control interface 622.

The first communication unit 616 can enable external communication to and from the first device 102. For example, the first communication unit 616 can permit the first device 102 to communicate with the second device 106 of FIG. 1, an attachment, such as a peripheral device or a computer desktop, and the communication path 104.

The first communication unit 616 can also function as a communication hub allowing the first device 102 to function as part of the communication path 104 and not limited to be an end point or terminal unit to the communication path 104. The first communication unit 616 can include active and passive components, such as microelectronics or an antenna, for interaction with the communication path 104.

The first communication unit 616 can include a first communication interface 628. The first communication interface 628 can be used for communication between the first communication unit 616 and other functional units in the first device 102. The first communication interface 628 can receive information from the other functional units or can transmit information to the other functional units.

The first communication interface 628 can include different implementations depending on which functional units are being interfaced with the first communication unit 616. The first communication interface 628 can be implemented with technologies and techniques similar to the implementation of the first control interface 622.

The first user interface 618 allows a user (not shown) to interface and interact with the first device 102. The first user interface 618 can include an input device and an output device. Examples of the input device of the first user interface 618 can include a keypad, a touchpad, soft-keys, a keyboard, a microphone, an infrared sensor for receiving remote signals, or any combination thereof to provide data and communication inputs.

The first user interface 618 can include a first display interface 630. The first display interface 630 can include a display, a projector, a video screen, a speaker, or any combination thereof.

The first control unit 612 can operate the first user interface 618 to display information generated by the navigation system 100. The first control unit 612 can also execute the first software 626 for the other functions of the navigation system 100. The first control unit 612 can further execute the first software 626 for interaction with the communication path 104 via the first communication unit 616.

The second device 106 can be optimized for implementing an embodiment of the present invention in a multiple device embodiment with the first device 102. The second device 106 can provide the additional or higher performance processing power compared to the first device 102. The second device 106 can include a second control unit 634, a second communication unit 636, and a second user interface 638.

The second user interface 638 allows a user (not shown) to interface and interact with the second device 106. The second user interface 638 can include an input device and an output device. Examples of the input device of the second user interface 638 can include a keypad, a touchpad, soft-keys, a keyboard, a microphone, or any combination thereof to provide data and communication inputs. Examples of the output device of the second user interface 638 can include a second display interface 640. The second display interface 640 can include a display, a projector, a video screen, a speaker, or any combination thereof.

The second control unit 634 can execute a second software 642 to provide the intelligence of the second device 106 of the navigation system 100. The second software 642 can operate in conjunction with the first software 626. The second control unit 634 can provide additional performance compared to the first control unit 612.

The second control unit 634 can operate the second user interface 638 to display information. The second control unit 634 can also execute the second software 642 for the other functions of the navigation system 100, including operating the second communication unit 636 to communicate with the first device 102 over the communication path 104.

The second control unit 634 can be implemented in a number of different manners. For example, the second control unit 634 can be a processor, an embedded processor, a microprocessor, hardware control logic, a hardware finite state machine (FSM), a digital signal processor (DSP), or a combination thereof.

The second control unit 634 can include a second controller interface 644. The second controller interface 644 can be used for communication between the second control unit 634 and other functional units in the second device 106. The second controller interface 644 can also be used for communication that is external to the second device 106.

The second controller interface 644 can receive information from the other functional units or from external sources, or can transmit information to the other functional units or to external destinations. The external sources and the external destinations refer to sources and destinations external to the second device 106.

The second controller interface 644 can be implemented in different ways and can include different implementations depending on which functional units or external units are being interfaced with the second controller interface 644. For example, the second controller interface 644 can be implemented with a pressure sensor, an inertial sensor, a microelectromechanical system (MEMS), optical circuitry, waveguides, wireless circuitry, wireline circuitry, or a combination thereof.

A second storage unit 646 can store the second software 642. The second storage unit 646 can also store map or mapping information. The second storage unit 646 can be sized to provide the additional storage capacity to supplement the first storage unit 614.

For illustrative purposes, the second storage unit 646 is shown as a single element, although it is understood that the second storage unit 646 can be a distribution of storage elements. Also for illustrative purposes, the navigation system 100 is shown with the second storage unit 646 as a single hierarchy storage system, although it is understood that the navigation system 100 can have the second storage unit 646 in a different configuration. For example, the second storage unit 646 can be formed with different storage technologies forming a memory hierarchal system including different levels of caching, main memory, rotating media, or off-line storage.

The second storage unit 646 can be a volatile memory, a nonvolatile memory, an internal memory, an external memory, or a combination thereof. For example, the second storage unit 646 can be a nonvolatile storage such as non-volatile random access memory (NVRAM), Flash memory, disk storage, or a volatile storage such as static random access memory (SRAM).

The second storage unit 646 can include a second storage interface 648. The second storage interface 648 can be used for communication between other functional units in the second device 106. The second storage interface 648 can also be used for communication that is external to the second device 106.

The second storage interface 648 can receive information from the other functional units or from external sources, or can transmit information to the other functional units or to external destinations. The external sources and the external destinations refer to sources and destinations external to the second device 106.

The second storage interface 648 can include different implementations depending on which functional units or external units are being interfaced with the second storage unit 646. The second storage interface 648 can be implemented with technologies and techniques similar to the implementation of the second controller interface 644.

The second communication unit 636 can enable external communication to and from the second device 106. For example, the second communication unit 636 can permit the second device 106 to communicate with the first device 102 over the communication path 104.

The second communication unit 636 can also function as a communication hub allowing the second device 106 to function as part of the communication path 104 and not limited to be an end point or terminal unit to the communication path 104. The second communication unit 636 can include active and passive components, such as microelectronics or an antenna, for interaction with the communication path 104.

The second communication unit 636 can include a second communication interface 650. The second communication interface 650 can be used for communication between the second communication unit 636 and other functional units in the second device 106. The second communication interface 650 can receive information from the other functional units or can transmit information to the other functional units.

The second communication interface 650 can include different implementations depending on which functional units are being interfaced with the second communication unit 636. The second communication interface 650 can be implemented with technologies and techniques similar to the implementation of the second controller interface 644.

The first communication unit 616 can couple with the communication path 104 to send information to the second device 106 in the first device transmission 608. The second device 106 can receive information in the second communication unit 636 from the first device transmission 608 of the communication path 104.

The second communication unit 636 can couple with the communication path 104 to send information to the first device 102 in the second device transmission 610. The first device 102 can receive information in the first communication unit 616 from the second device transmission 610 of the communication path 104. The navigation system 100 can be executed by the first control unit 612, the second control unit 634, or a combination thereof. For illustrative purposes, the second device 106 is shown with the partition having the second user interface 638, the second storage unit 646, the second control unit 634, and the second communication unit 636, although it is understood that the second device 106 can have a different partition. For example, the second software 642 can be partitioned differently such that some or all of its function can be in the second control unit 634 and the second communication unit 636. Also, the second device 106 can include other functional units not shown in FIG. 6 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the navigation system 100 is described by operation of the first device 102 and the second device 106. It is understood that the first device 102 and the second device 106 can operate any of the modules and functions of the navigation system 100.

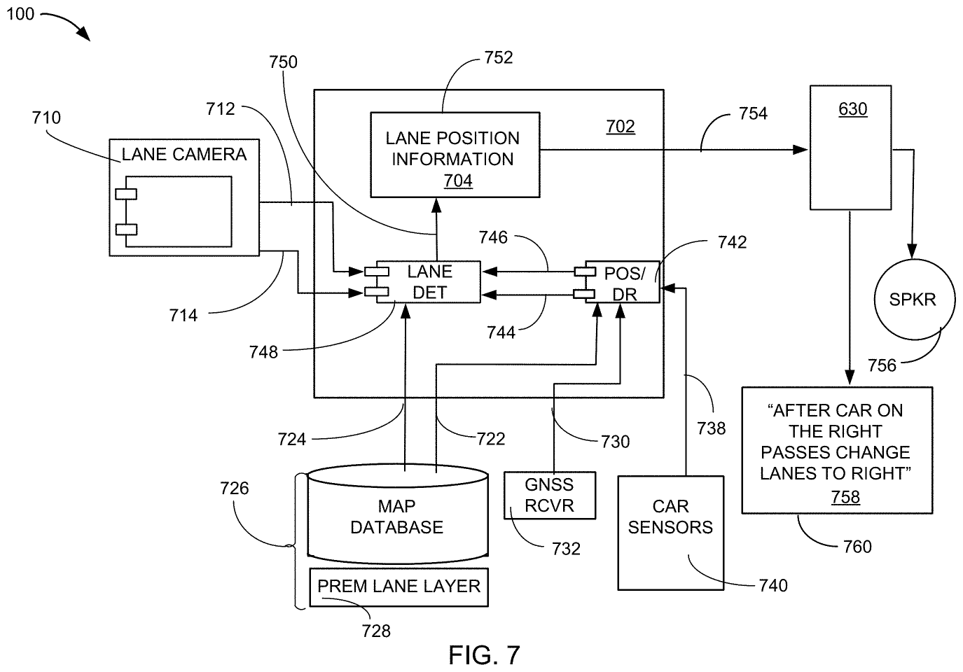

Referring now to FIG. 7, therein is a further exemplary block diagram of a lane management system 701. As an example, the lane management system 701 can include a navigation processing block 702. The navigation processing block 702 is for generating the information about the lane position 208 of FIG. 2 of the user vehicle 212 of FIG. 2 on the current roadway 206 of FIG. 2 based on various sources of information. For example, the navigation processing block 702 can generate maneuver information 704, such as the total number of the roadway lanes 210 of FIG. 2 on the current roadway 206, the location of the lane delineation estimations 204 of FIG. 2 for roadway lanes 210, the lane position 208 of the user vehicle 212 on the current roadway 206, or a combination thereof and associated confidence levels. The navigation processing block 702 can be a hardware structure configured to generate the lane position information 704 based on sensor information 738, user vehicle location information 730, map information 722, or a combination thereof. Details regarding generating the lane position information 704 will be discussed below.

The sensor information 738 can be information recorded or measured by a sensor unit 740, about the area or environment surrounding the user vehicle 212. The sensor information 738, can include various types of information regarding objects, such as the proximately located vehicles 214 of FIG. 2, surrounding the user vehicle 212 and can be provided in a number of different formats and states. The format of the sensor information 738 can be based on the source of the sensor information 738. For example, the state of the sensor information 738 can be raw or unprocessed information, such as raw signals or images, partially processed information, or processed information. More specifically, the sensor information 738 can be raw or unprocessed information or partially processed information sensor readings measured or recorded by sensor unit 740.

The sensor unit 740 can be a hardware device that includes sensors and detection instruments for monitoring the user vehicle 212 and the immediate surroundings. For example, the sensor unit 740 can include one or more instruments or sensors, such as a camera, a microphone, an infrared detector, a radar detector, a light detection and ranging (LIDAR) unit, an inertial measurement unit (IMU), or a combination thereof. The sensor unit 740 can include instruments and sensors attached to or integrated with the user vehicle 212 or external to the user vehicle 212, such as sensors or instruments mounted on the side of the current road 206. In an implementation, the sensor unit 740 can be a part of or coupled to the first device 102, the second device 106, or a combination thereof. By way of an example the sensor unit 740 can be the equivalent of the first device sensor array 623 of FIG. 6 coupled to the first controller interface 622 of FIG. 6. As an example, the sensor unit can include multiple instances of a sensor type integrated with or mounted at different locations in or on the user vehicle 212

The user vehicle location information 730, which is the geographic or physical location of the user vehicle 212. For example, the user vehicle location information 730 can interface with the location unit 620 of FIG. 6 of the first device 102 to determine the user vehicle location information 722, such as a global positioning system (GPS) or a global navigation satellite system (GNSS) coordinates or the longitude and latitude of the user vehicle 212 provided by a GNSS receiver 732.

The map information 722 is information representing a geographic area proximate the user vehicle 212. For example, the map information 722 can correspond to the position of the user vehicle 212 of FIG. 2 and can include information about travel infrastructure, such as the current road 206 and highways; specific location information, such as building addresses; geographic features, such as terrain, bodies of water, and topography; or a combination thereof. As a specific example, the map information 722 can include lane information 724. The lane information 724 provides details about the current roadway 206. For example, the lane information 724 can be information about the number and dimensions of the lane position 208 on the current road 206. The lane information 724 can include information, such as a count of the roadway lanes 210 for the current roadway 206, which is a count of the number of the roadway lanes 210, an estimated width of the roadway lanes 210, the existence and width of a road shoulder area, a total estimated width of the roadway, a speed limit, or a combination thereof. In another specific example, the map information 722 can include information of related roadways, such as intersections with the current roadway 206, including merge section 228 of FIG. 2 information such as the location and length of the lane merge section 228.

The map information 722 and the lane information 724 can be stored in a map database 726, which includes a premium lane layer 728, that can provide the information about the roadway lanes 210 in an area of interest around the user vehicle 212. A position and direction module 742 can receive the map information 722, the user vehicle location information 730, and the sensor information 738 in order to calculate an absolute position 744 and a current speed 746 of the user vehicle 212.

The position and direction module 742 can be a hardware device configured to identify the absolute position 744 and a current speed 746 of the user vehicle 212. The position and direction module 742 can be coupled to a lane determination module 748 that can receive the absolute position 744, the current speed 746 of the user vehicle 212, and the lane information 724 in order to identify which of the roadway lanes 210 in the current road 206 the user vehicle is actually travelling in.

The lane determination module 748 can also receive input from a lane camera 710, which can identify the lane position 208, monitor lane markings, and identify the proximately located vehicles 214 or other obstructions. The lane camera 710 can be a hardware camera configured to provide visual reference for the lane position 208, the markings of the roadway lanes 210, and the proximately located vehicles 214. The lane determination module 748 can combine the lane information 724 with a visual detection stream 712 and a camera feed 714 in order to generate a lane information 750. The lane determination module 748 can be coupled to an output device 752, which can receive the lane information 750 and process the lane position information 704. The output device 752 can be a hardware processor, analog circuitry, a sequential state machine, or digital application specific integrated circuit (ASIC), or the like. The output device 752 can transfer an announcement 754, composed from the lane position information 704, to the first user interface 618, of FIG. 6 for presentation to the operator of the user vehicle 212. The first user interface 618 can be coupled to a speaker 756 in order to deliver audio queues and a content 758, of the announcement 754, can be presented on a display screen 760. The lane management system 701 can manage the announcement 754 by adjusting the presentation timing, referencing the proximately located vehicles 214, modifying the content 758 to better inform the operator of the user vehicle 212 of the navigation instruction 306.

It has been discovered that the lane management system 701 can look ahead for lane closures due to construction, accidents, natural disasters, or the like. The map database 726 can provide a framework of the number and details of the roadway lanes 210 that would normally be available for use. The second device 106 of FIG. 1 can provide updates for the map database 726 for updating availability changes in the roadway lanes 210, active traffic and closure information for the roadway lanes 210. By providing a look-ahead planning of the utilization of the roadway lanes 210, the lane management system 701 can guide the user vehicle 212 in an efficient manner without being overly chatty with the audio announcements.

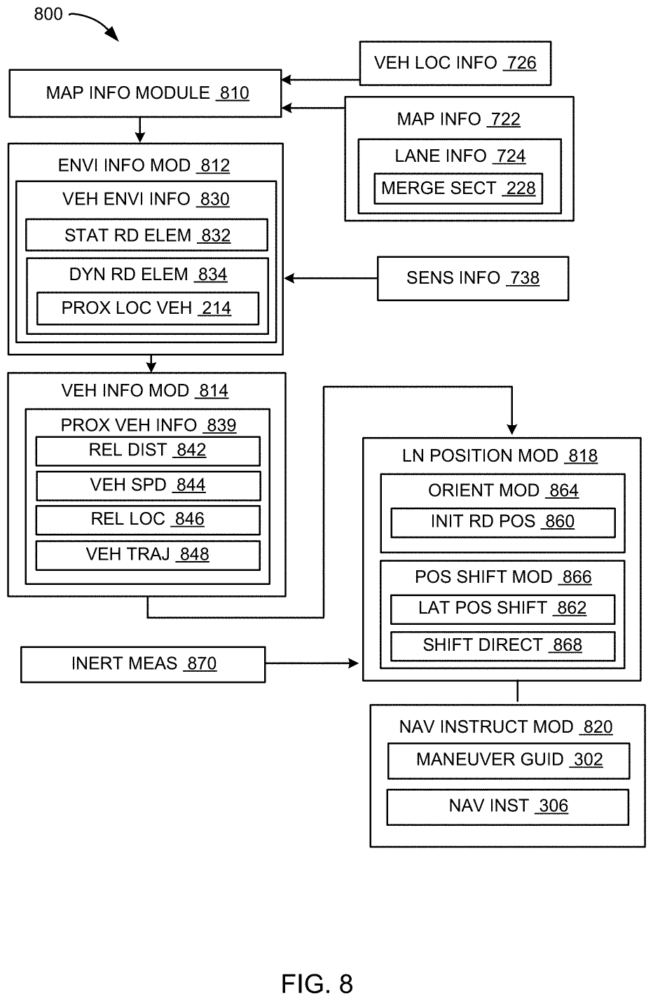

Referring now to FIG. 8, therein is shown a block diagram of a control flow 800 of the navigation system 100 in an embodiment of the present invention. The control flow 800 can be for determining the lane position 208 of the user vehicle 212, generating the maneuver guidance 302, or a combination thereof which will be described below. The navigation system 100 can include a map information module 810, an environment information module 812, a vehicle information module 814, a lane position module 818, an instruction generation module 820, or a combination thereof. The environment information module 812 can be coupled to the map information module 810. The vehicle information module 814 can be coupled to the environment information module 812. The lane position module 818 can be coupled to the vehicle information module 814. The instruction generation module 820 can be coupled to the lane position module 818.

The map information module 810 is for processing the map information 722 corresponding to the position of the user vehicle 212 of FIG. 2. For example, the map information module 810 can utilize the user vehicle location information 726 to determine the map information 722. As a specific example, the map information module 810 can interface with the location unit 620 of FIG. 6 of the first device 102 to determine the user vehicle location 726, such as the GPS coordinates or the longitude and latitude of the user vehicle 212. To continue the example, the map information module 810 can utilize the user vehicle location 726 to get the map information 722 for the geographic area around the user vehicle 212.

The control flow 800 can pass to the environment information module 812. The environment information module 812 is for collecting information about the environment around the user vehicle 212. For example, the environment information module 812 can process vehicle environment information 830, which is information regarding objects surrounding the user vehicle 212. For example, the vehicle environment information 830 can be information about a vehicle environment, which is the environment external to and surrounding the vehicle, and can include information about static road elements 832, dynamic road elements 834, or a combination thereof. It is understood that the static road elements 832 can include guard rails, sound walls, lane dividers, or the like. It is further understood that the dynamic road elements can include the proximately located vehicles 214, toll roads, draw bridges, traffic accidents, construction detours, and natural temporary obstacles like flooding or wildfires.

The static road elements 832 are fixed objects at a static location within the environment around the user vehicle 212. For example, the static road elements 832 can be objects that are fixed or unlikely to change position over the passage of time. As a specific example, the static road elements 832 can be specific to the current roadway 206, such as lane markings, sign posts, road barriers, pylons, trees, or buildings.

The dynamic road elements 834 are objects that change within the environment around user vehicle 212. The dynamic road elements 834 can be objects that are in motion or are temporary within the vehicle environment. For example, the dynamic road elements 834 can include the proximately located vehicles 214.

The environment information module 812 can collect the vehicle environment information 830 in a number of ways. In one implementation, the vehicle environment information 830 can be information received through communication or interfacing with the proximately located vehicles 214; information accumulated from sensors or detection instruments; information received from other sources external to the user vehicle 212 or the first device 102, such as the second device 106 of FIG. 1 or the communication path 104 of FIG. 1; or a combination thereof. More specifically, the first control unit 612 can implement the first communication unit 616 with the environment information module 812 to communicate with devices external to the first device 102, such a communication unit of the proximately located vehicles 214 of FIG. 2 or a traffic server.

In another implementation, the environment information module 812 can collect the vehicle environment information 830 the sensor information 738. For example, the environment information module 812 can collect the vehicle environment information 830 by sending commands or requests to a sensor unit to take various readings, which can be transmitted back to the environment information module 812 as the sensor information 738.

The map information module 810 can receive the map information 722 from various sources. For example, the map information module 810 can receive the map information 722 stored in the first storage unit 614 of FIG. 6 of the first device 102. In another example, the map information module 810 can receive the map information 722 from a device other than the first device 102, such as an external storage unit or server, the second storage unit 642 of FIG. 6, or a combination thereof.

The control flow can pass to the vehicle information module 814. The vehicle information module 814 is for determining proximate vehicle information 839, which is information about the proximately located vehicles 214. More specifically, the vehicle information module 814 can determine the proximate vehicle information 839 from the vehicle environment information 830.

For example, the vehicle information module 814 can determine the proximate vehicle information 839 from the vehicle environment information 830 for one or more instances of the proximately located vehicles 214. As a specific example, the vehicle information module 814 can identify patterns in the vehicle environment information 830 that are recognized as a vehicle, such as heat signatures, noise, sounds, vibrations, illumination, emissions, movement heading, speed, acceleration, deceleration, movement patterns, physical location, position, shape, size, or any combination thereof. As another specific example, the vehicle information module 814 can compare or corroborate information between different types or sources of the vehicle environment information 830 such as different instances or types of the sensor unit 740 of FIG. 7. To continue the specific example, the vehicle information module 814 can compare, corroborate, cross-verify or a combination thereof the vehicle environment information 830 based on the sensor information 738 from an infrared sensor for heat signatures, a LIDAR unit, microphones, cameras, pressure sensors, or other types of the sensor units to determine the proximate vehicle information 839.

In a further example, the vehicle information module 814 can calculate a relative distance 842, a vehicle speed 844, a vehicle trajectory 848, or a combination thereof for the proximately located vehicles 214 based on the vehicle environment information 830. As a specific example, the vehicle information module 814 can calculate the vehicle speed 236 and the vehicle trajectory 848 based on changes and the rate of changes in a relative location 846, a relative distance 842, or a combination thereof over a specific period of time.

The control flow can pass to the lane position module 818. The lane position module 818 is for calculating the lane position 208 of the user vehicle 212. In one implementation, the lane position module 818 can calculate the lane position 208 of the user vehicle 212 on the current roadway 206 based on an initial roadway position 860 and a lateral position shift 862 of the user vehicle 212. The lateral position shift 862 is a shift in position of the user vehicle 212 that is perpendicular to the axis of travel of the user vehicle 212, such as the lane merger 504 of FIG. 5.

The initial roadway position 860 is the initial location of the user vehicle 212 upon entry of the user vehicle 212 on the current roadway 206. For example, the initial roadway position 860 of the user vehicle 212 can be the vehicle location 826 of the user vehicle 212 upon entry of the user vehicle 212 onto the current roadway 206, such as after transitioning from an on-ramp, a street, or parking area onto the current roadway 206.

The lane position module 818 can determine the initial roadway position 860 of the user vehicle 212 with an orientation module 864. The orientation module 864 can determine the initial roadway position 860 based on the user vehicle location 822, the map information 822, or a combination thereof. For example, the orientation module 864 can monitor the user vehicle location 822 relative to the map information 822 to determine when the user vehicle 212 has transitioned on to the current roadway 206. To continue the example, the initial roadway position 860 can be determined over a post-transition distance following entry onto the current roadway 206, such as on the lane merge section 228. As a specific example, the post-transition distance can be a distance of 10 to 20 meters from the point of entry onto the current roadway 206, since vehicles tend to travel in the initial lane of entry over a short distance before engaging in further of the lane change maneuvers 318.

The orientation module 864 can determine the initial roadway position 860 based on the entry location to the current roadway 206. For example, the initial roadway position 860 can be on the right side of the current roadway 206 when the entry location is on the right side of the current roadway 206 and on the left side of the current roadway 206 when the entry location is on the left side of the current roadway 206.

The lane position module 818 can determine the lateral position shift 862 for the user vehicle 212 with the position shift module 866. The position shift module 866 can determine the lateral position shift 862 based on the force and duration of lateral shifts 216 of FIG. 2 corresponding to a distance of the lane width for the lane delineation estimations 204 of the road lane model 202. As an example, the position shift module 866 can receive an inertial measurement 870 from inertial measurement unit to determine the lateral position shift 862.

The position shift module 866 can include a determination of a shift direction 868 associated with the lateral position shift 862. The shift direction 868 is the lateral direction in which the lateral position shift 862 occurred. As an example, the shift direction 868 can be based on the inertial measurement 870 from the inertial measurement unit.

The lane position module 818 can calculate the lane position 208 of the user vehicle 212 relative to the initial roadway position 860 of the user vehicle 212. For example, the lane position module 818 can calculate the lane position 208 relative to initial roadway position 860 according to the number of lateral position shift 862 and the associated shift direction 868. To continue the example, the lane position module 818 can correlate each instance of the lateral position shift 862 and associated shift direction 868 to the lane delineation estimations 204 of the road lane model 202. In another example, in the case that the current roadway 206 includes a curve or bend, the lane position module 818 can determine the change in the lane position 208 according the lack of the lateral position shift 862 or a reduced amount of the lateral position shift 862, according to the degree of the curvature for the current roadway 206, relative to the degree of the lateral position shift 862 that would occur during the change in the lane position 208 on a straight section.

The control flow can pass to the instruction generation module 820. The instruction generation module 820 is for generating the maneuver guidance 302. As an example, the maneuver guidance 302 can use the map information 722, the user vehicle location information 730, the current lane position 208 of the user vehicle 212, the proximate vehicle information 214, or a combination thereof to generate the maneuver guidance 302, which can include the navigation instructions 306.

In one embodiment, for example, during an active navigation session, the instruction generation module 820 can monitor for upcoming instances of the navigation event 304 along a navigation route based on the map information 722. When the upcoming instance of the navigation event 304 is detected, the instruction generation module 820 can check the current lane position 208 of the user vehicle 212 along the current roadway 206 and the event distance 303 of the navigation event 304. Based on the event distance 303 and the current lane position 208 of the user vehicle 212, the instruction generation module 820 can generate the navigation instructions 306 and determine the notification timing for when the navigation instructions 306 are provided to perform a particular maneuver with the user vehicle 212. The notification timing can be determined to factor in the vehicle speed that the user vehicle 212 is traveling, the current average vehicle speed on that section or portion of the current roadway 206, or the speed limit of that current roadway 206, the number and speed of the proximately located vehicles 214. The instruction generation module 820 can generate the maneuver guidance 302 to include the navigation instructions 306 for the information phase 310, the preparation phase 312, the action phase 314, or a combination thereof, as necessary for the navigation event 304.

In another embodiment, for example, during an active navigation session, the instruction generation module 820 can monitor for upcoming instances of the navigation event 304 along the roadway lane 210 for the current lane position 208 of the user vehicle 212 based on the map information 722. When the instruction generation module 820 detects the navigation event 304, the instruction generation module 820 can generate the navigation instructions 306 and determine the notification timing for when the navigation instructions 306 are provided to perform a particular maneuver with the user vehicle 212. The notification timing can be determined to factor in the vehicle speed that the user vehicle 212 is traveling, the current average vehicle speed on that section or portion of the current roadway 206, or the speed limit of that current roadway 206, the number and speed of the proximately located vehicles 214. The instruction generation module 820 can generate the maneuver guidance 302 to include the navigation instructions 306 for the information phase 310, the preparation phase 312, or a combination thereof, as necessary for the navigation event 304.

It has been discovered that the navigation system 100 provides safer and more environment aware operation by issuing the managed set of the navigation instructions 306 to the user vehicle 212 based on the current lane position 208 of the user vehicle 212, the presence of the proximately located vehicles 214 and the distance 303 to the navigation event 304. The navigation system 100 can generate the maneuver guidance 302 that is specific to the current lane position 208 for the navigation event 304, which improves the ability of the system user to safely operate the user vehicle 212 on the current roadway 206.

The navigation system 100 has been described with module functions or order as an example. The navigation system 100 can partition the modules differently or order the modules differently. For example, the map information module 810 can be coupled to the instruction generation module 820.

For illustrative purposes, the various modules have been described as being specific to the first device 102 or the second device 106. However, it is understood that the modules can be distributed differently. For example, the various modules can be implemented in a different device, or the functionalities of the modules can be distributed across multiple devices. Also as an example, the various modules can be stored in a non-transitory memory medium.

As a more specific example, one or more modules described above can be stored in the non-transitory memory medium for distribution to a different system, a different device, a different user, or a combination thereof, for manufacturing, or a combination thereof. Also as a more specific example, the modules described above can be implemented or stored using a single hardware unit, such as a chip or a processor, or across multiple hardware units.

The modules described in this application can be hardware implementation or hardware accelerators in the first control unit 616 of FIG. 6 or in the second control unit 638 of FIG. 6. The modules can also be hardware implementation or hardware accelerators within the first device 102 or the second device 106 but outside of the first control unit 616 or the second control unit 638, respectively, as depicted in FIG. 6. However, it is understood that the first control unit 616, the second control unit 638, or a combination thereof can collectively refer to all hardware accelerators for the modules.

The modules described in this application can be implemented as instructions stored on a non-transitory computer readable medium to be executed by a first control unit 612, the second control unit 636, or a combination thereof. The non-transitory computer medium can include the first storage unit 614 of FIG. 6, the second storage unit 646 of FIG. 6, or a combination thereof. The non-transitory computer readable medium can include non-volatile memory, such as a hard disk drive, non-volatile random access memory (NVRAM), solid-state storage device (SSD), compact disk (CD), digital video disk (DVD), or universal serial bus (USB) flash memory devices. The non-transitory computer readable medium can be integrated as a part of the navigation system 100 or installed as a removable portion of the navigation system 100.

The physical transformation from determining the lane position 208 of the user vehicle 212 results in the movement in the physical world, such as maneuvering the user vehicle 212 based on the navigation event 304. Movement in the physical world, such movement of the user vehicle 212, results in changes to the maneuver guidance 302 based on the lane position 208 of the user vehicle.

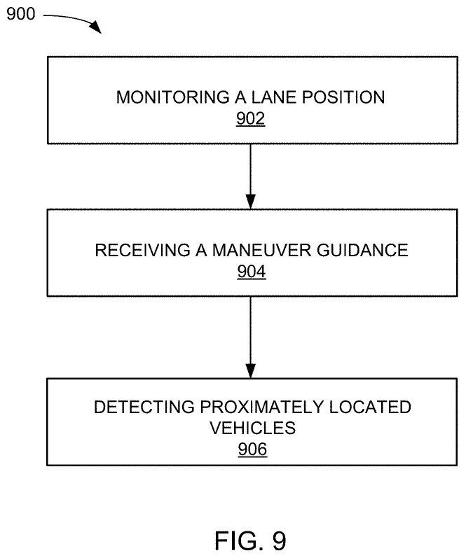

Referring now to FIG. 9, therein is shown a flow chart of a method 900 of operation of the navigation system 100 in a further embodiment of the present invention. The flow chart of the method 900 includes: monitoring a lane position of a first device in a block 902; receiving a maneuver guidance by the first device based on the lane position, including an information phase, a preparation phase and an action phase prior to the first device making a driving maneuver in a block 904; and detecting a proximately located vehicle around the first device prior to announcing a navigation instruction including managing an announcement of the navigation instruction based on the lane position, the proximately located vehicle, and a distance to a navigation event in a block 906.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance.

These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A navigation system comprising:
a first device configured to:
monitor a lane position on a current road,
receive a maneuver guidance based on the lane position, including an information phase, a preparation phase and an action phase prior to the first device making a driving maneuver, and
detect a proximately located vehicle around the first device prior to announcing a navigation instruction including managing an announcement of the navigation instructions based on the lane position, the proximately located vehicle, and a distance to a navigation event on the current road.

2. The system as claimed in claim 1 wherein the first device is further configured to receive the maneuver guidance when driving in an open navigation session including receiving a preparation phase announcement that the first device is in an exit-only lane.

3. The system as claimed in claim 1 wherein the first device is further configured to receive the maneuver guidance when driving in an open navigation session including that the first device is in a terminated lane.

4. The system as claimed in claim 1 wherein the first device is further configured to receive the maneuver guidance when driving in an open navigation session including the first device is approaching the end of a merging lane.

5. The system as claimed in claim 1 wherein the first device is further configured to monitor a lane camera, lateral shifts, and a map database to determine the lane position for managing the announcement and the content of the navigation instruction.

6. The system as claimed in claim 1 further comprising a second device, coupled to the first device, configured to update the map database including notifying the first device of the roadway lane that is closed by issuing the maneuver guidance for a lane change.

7. The system as claimed in claim 1 wherein the first device is further configured to monitor the lane position by detecting a lateral shift of a lane change.

8. A method of operation of a navigation system comprising:
monitoring a lane position of a first device;
receiving a maneuver guidance by the first device based on the lane position, including an information phase, a preparation phase and an action phase prior to the first device making a driving maneuver; and
detecting a proximately located vehicle around the first device prior to announcing a navigation instruction including managing an announcement of the navigation instructions based on the lane position, the proximately located vehicle, and a distance to a navigation event.

9. The method as claimed in claim 8 further comprising driving in an open navigation session and receiving the maneuver guidance including receiving a preparation phase announcement that the first device is in an exit-only lane.

10. The method as claimed in claim 8 further comprising driving in an open navigation session and receiving the maneuver guidance including that the first device is in a terminated lane.

11. The method as claimed in claim 8 further comprising driving in an open navigation session and receiving the maneuver guidance when the first device is approaching the end of a merging lane.

12. The method as claimed in claim 8 wherein managing the announcement and content of the navigation instructions includes monitoring a lane camera, lateral shifts, and a map database to determine the lane position.

13. The method as claimed in claim 8 further comprising updating the map database including updating the availability of the roadway lanes that are closed due to construction, traffic accidents, or natural disasters.

14. The method as claimed in claim 8 wherein monitoring the lane position includes detecting a lateral shift of a lane change.

15. A non-transitory computer readable medium including instructions for execution, the instructions comprising:
monitoring a lane position of a first device;
receiving a maneuver guidance by the first device based on the lane position, including an information phase, a preparation phase and an action phase prior to the first device making a driving maneuver; and
detecting a proximately located vehicle around the first device prior to announcing a navigation instruction including managing an announcement of the navigation instruction based on the lane position, the proximately located vehicle, and a distance to a navigation event.

16. The medium as claimed in claim 15 further comprising driving in an open navigation session and receiving the maneuver guidance including receiving a preparation phase announcement that the first device is in an exit-only lane.

17. The medium as claimed in claim 15 further comprising driving in an open navigation session and receiving the maneuver guidance including that the first device is in a terminated lane.

18. The medium as claimed in claim 15 further comprising driving in an open navigation session and receiving the maneuver guidance when the first device is approaching the end of a merging lane.

19. The medium as claimed in claim 15 wherein managing an announcement and content of the navigation instructions by monitoring a lane camera, lateral shifts, and a map database to determine the lane position.

20. The medium as claimed in claim 15 further comprising updating the map database including updating the availability of the roadway lanes that are closed due to construction, traffic accidents, or natural disasters.
